(19) United States
(12) Patent Application Publication
(10) Pub. No.: US 2024/0378653 A1
(43) Pub. Date: Nov. 14, 2024

(54) DATA EXTRACTION AND DATA INGESTION FOR EXECUTING SEARCH REQUESTS ACROSS MULTIPLE DATA SOURCES

(71) Applicant: Limble Solutions, Inc., Lehi, UT (US)

(72) Inventors: Bryan Christiansen, Eagle Mountain, UT (US); Ed Chalon, Parish, NY (US); Jeff Babb, Vineyard, UT (US); Jordan Bush, Idaho Falls, ID (US); Michael DeMille, Draper, UT (US); Scott Knudson, Sandy, UT (US)

(73) Assignee: Limble Solutions, Inc., Lehi, UT (US)

(21) Appl. No.: 18/661,441

(22) Filed: May 10, 2024

Related U.S. Application Data
(60) Provisional application No. 63/501,356, filed on May 10, 2023.

(51) Int. Cl. G06Q 30/0601

(52) U.S. Cl. CPC G06Q 30/0625; G06Q 30/0641

(57) ABSTRACT

Systems, methods, and devices for data extraction and data ingestion. A method includes receiving a search request comprising a product descriptor and searching a plurality of vendor websites to identify a plurality of product listings that each comprise information matching the product descriptor. The method includes extracting data from each of the plurality of product listings, wherein the extracted data comprises unstructured data. The method includes providing at least a portion of the extracted data to a machine learning algorithm trained to identify one or more unique part attributes within the portion of the extracted data. The method includes determining whether two or more of the plurality of product listings are duplicate product listings based on the one or more unique part attributes identified by the machine learning algorithm.

### CROSS-REFERENCE TO RELATED APPLICATIONS

This application claims the benefit of U.S. Provisional Patent Application No. 63/501,356, filed May 10, 2023, titled “DATA EXTRACTION AND DATA INGESTION FOR EXECUTING SEARCH REQUESTS ACROSS MULTIPLE DATA SOURCES,” which is incorporated herein by reference in its entirety, including but not limited to those portions that specifically appear hereinafter, the incorporation by reference being made with the following exception: In the vent that any portion of the above-reference provisional patent application is inconsistent with this application, this application supersedes the above-reference provisional patent application.

### TECHNICAL FIELD

The present disclosure relates to systems and methods for data extraction and data ingestion, and specifically to executing a search request across multiple data sources.

### BACKGROUND

In many industries, and particularly in manufacturing, construction, and retail industries, it is important to regularly acquire products for use and/or resale. Specifically in manufacturing and construction industries, it is important to ensure that all parts necessary to the smooth operation of existing machinery are acquired regularly to ensure systems continue functioning on-schedule. Thus, across numerous industries such as manufacturing, construction, and retail sales, there may be one or more persons dedicated to identifying which products must be acquired, when those products must be acquired, where those products may be acquired, and the pricing for the products across various vendors.

Searching for a specific product across multiple vendor websites can be time consuming and challenging, and particularly if the vendor websites have different search interfaces and naming conventions for the same products. Some of the difficulties encountered in this process include inconsistencies in terminology, limited search capabilities, different product categories, varying pricing and availability, and varying shipping and handling policies. For example, different vendors may use different names or search terms for the same part, and this makes it difficult to search for the correct item across multiple websites. This can lead to confusion and wasted time. Additionally, some vendor websites have limited search capabilities, making it difficult to find the specific product needed. In some cases, a user may need to manually search through pages of products to identify the correct listing. Additionally, different vendors may categorize products differently on their websites, making it difficult to compare products across vendors. Overall, searching for a product across multiple vendor websites can be a complex and time-consuming process.

Some specialized search engines or aggregators exist in the prior art for searching across multiple vendor websites and providing a unified view of the results. However, these existing search engines are tuned to search generic product terms rather than unique part attributes. In the manufacturing, constructing, and retail sales industries as described herein, it can be essential to find specific parts that have a unique part number or other unique part attribute associated with a certain manufacturer. Existing search engines fail to provide an efficient means for identifying a plurality of vendors currently supplying an identified part.

In view of the foregoing, described herein are systems, methods, and devices for data extraction and data ingestion for executing search requests across multiple data sources. The systems, methods, and devices described herein are necessarily rooted in computer technology and are necessitated by the use of electronic commerce systems that leverage web-based searching to identify certain products across a vast number of electronic commerce retailers.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. It will be appreciated by those of ordinary skill in the art that the various drawings are for illustrative purposes only. The nature of the present disclosure, as well as other embodiments in accordance with this disclosure, may be more clearly understood by reference to the following detailed description, to the appended claims, and to the several drawings.

FIG. 1A is a schematic diagram of a system for data aggregation that can be implemented for increasing efficiency of computing systems for ingesting, storing, and analyzing data;

FIG. 1B is a schematic block diagram illustrating various component and modules of a data harvesting platform as described herein;

FIG. 2 is a schematic block diagram of a system for automated data extraction and data ingestion for executing a search request across multiple data sources;

FIGS. 3A-3C are schematic block diagrams of a process flow for executing a search request across multiple data sources;

FIGS. 4A-4C are schematic block diagrams of a system for automated data extraction and data ingestion for executing a search request across multiple data sources;

FIG. 5 is a schematic block diagram of a process flow for automated data extraction and data ingestion for executing a search request across multiple data sources;

FIG. 6 is a schematic flow chart diagram of a method for generating a search result comprising an identification of one or more vendors supplying an identified product;

FIG. 7 is a schematic flow chart diagram of a method for updating a database table with product information in real-time based on data automatically extracted from one or more vendor websites;

FIG. 8 is a schematic flow chart diagram of a method for generating a search report for a user project, wherein the search report includes a listing indicating availability and pricing for acquiring a product from a plurality of different product suppliers;

FIG. 9 is a schematic flow chart diagram of a method for executing a search request across multiple data sources; and

FIG. 10 illustrates a block diagram of an example computing device in accordance with the teachings and principles of the disclosure

### DETAILED DESCRIPTION

Disclosed herein are systems, methods, and devices for automated data extraction and data ingestion. Additionally disclosed herein are systems, methods, and devices for executing a unique search request for an identified product or part attribute, wherein the unique search request simultaneously extracts up-to-date information in real-time from a plurality of vendor websites to indicate current availability and pricing for an identified product or part attribute.

The systems and methods described herein are executed to improve user experience when searching for a specific product available from multiple different electronic commerce vendors. In traditional web-based searching systems, users are required to manually search multiple different websites. This can be challenging and frustrating for a user, and particularly when the different websites utilize different searching algorithms, different filtering mechanisms, and offer different filtering variables. This is time consuming, and the lost time is directly attributable to the issues associated with web-based searching across electronic commerce vendors. The systems, methods, and devices described herein improve the functioning of computers and the efficiency of web-based searching to improve user experience when searching for certain products on the Internet.

The most common solution for sourcing products is for a person to conduct multiple web-based or app-based searches over the Internet. This person typically searches for the product they need from multiple sources, including, for example, the original manufacturer, large product distributors, and local retailers. It is common for the searching user to spend 15-30 minutes searching for each product. Depending on how frequently the products are required, these searches may be conducted anywhere from multiple times per month to multiple times every hour. The most frequent reason for searching multiple vendors is to reduce spend, and in most cases, the lowest cost vendor is selected. Some companies and individual elect to stop searching each time they require a product. Instead, these companies and individuals may select a vendor that meets their needs and then no longer search for alternatives. This presents the advantage of saving time, but typically results in overspending on products.

The systems and methods described herein offer numerous advantages over the search engines and data harvesting methods known in the art. Specifically, the systems and methods described herein search a plurality of data sources and providing real-time pricing information from multiple vendors. The results may be sorted based on price and availability for a specific product having a unique part attribute, such as a unique part number, model number, or serial number. Many search tools known in the art, including, for example, Google® and Amazon® can show the least expensive item associated with a given search, but fail to identify only the specific item being searched that has the correct unique part attribute, such as the correct unique part number, model number, or serial number.

The systems and methods described herein can reduce a traditionally lengthy searching process into a searching query that takes only a few seconds. This allows users to save time and select the least expensive vendors when preparing product purchase orders. In some implementations, the systems and methods described herein are specifically applied to Maintenance Repair and Operations/Overhaul (MRO) processes. In a single session, maintenance repair parts can be added to individual shopping carts for one or more vendors. If a company has negotiated pricing with a specific vendor, the systems and methods described herein will automatically display the negotiated price in lieu of displaying the public-facing listing price. The systems and methods described herein can further be leveraged to compare estimated shipping times and/or whether certain products could be picked up locally.

The systems and methods described herein additionally present improved means for data aggregation. Data aggregation, in general, presents numerous challenges and these challenges are aggravated when data is retrieved from disparate sources that implement different protocols and conventions for classifying information. Even when data is gathered and summarized, further analysis is usually required before the aggregated data can be shared with, or communicated to, different audiences, or used as the basis for decision-making. Data aggregation includes collecting data, checking the data, verifying the data, transferring the data, and compiling the data, assessing quality of the data, packaging the data, disseminating the data, and reporting the data, and using the data for action. Each of these steps presents unique technical challenges when the data is retrieved from disparate sources that implement different conventions and protocols for classifying and organizing information.

Additionally, the systems and methods described herein present improved means for data scraping. Data scraping, also known as web scraping or data harvesting, is the process of extracting data from websites or other online sources using automated software tools. The systems and methods described herein include a data scraping module that uses intelligent algorithms to identify and extract relevant data from various online sources. The data scraping module can be configured to search for specific keywords, URLs, or other criteria to ensure that the data collected is relevant to the user's needs. Once the data is collected, the system includes an automated ingestion module that processes and organizes the data into a format that can be easily analyzed and used by downstream applications. The ingestion module can apply various data normalization and transformation techniques to ensure the data is consistent and accurate.

Considering the foregoing, disclosed herein are systems, methods, and devices for resolving the technical challenges presented when aggregating data retrieved from one or more communication channels. The systems, methods, and devices described herein include means for securely and efficiently ingesting files and datapoints from a plurality of different sources, and then analyzing those files and datapoints to identify common classifications for the information described therein. The systems, methods, and devices described herein are implemented for classifying information, translating data describing the information, and then matching the data to “data buckets” that are associated with certain projects.

Before the structure, systems, and methods are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

The computer readable storage medium described herein can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

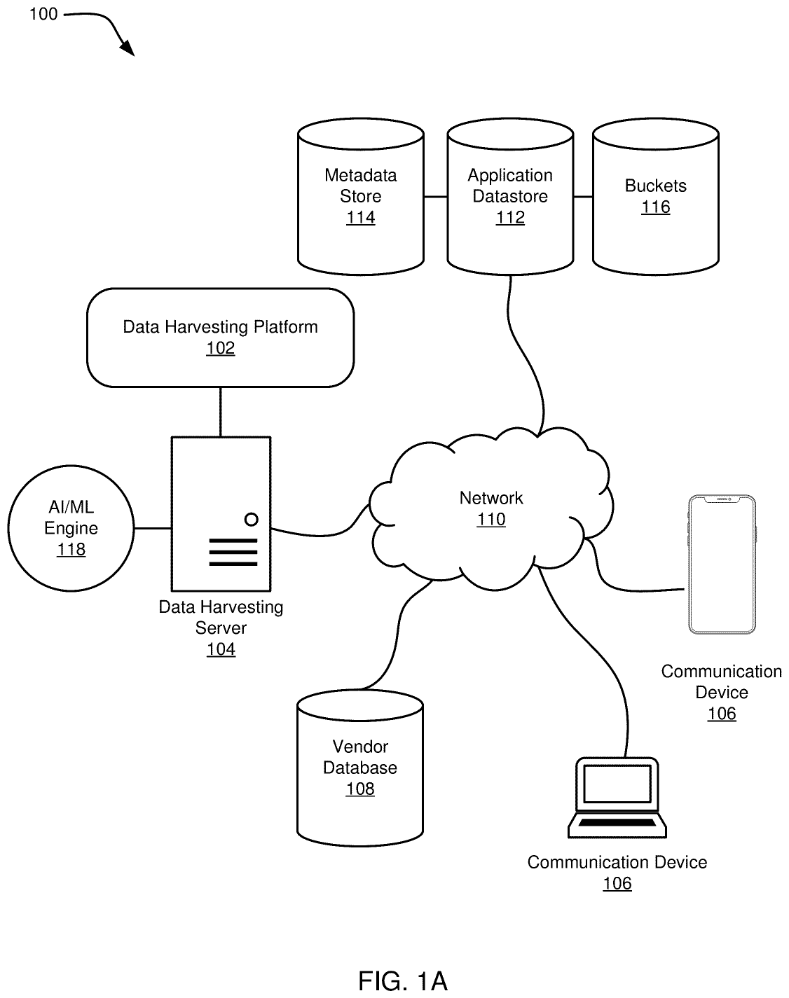

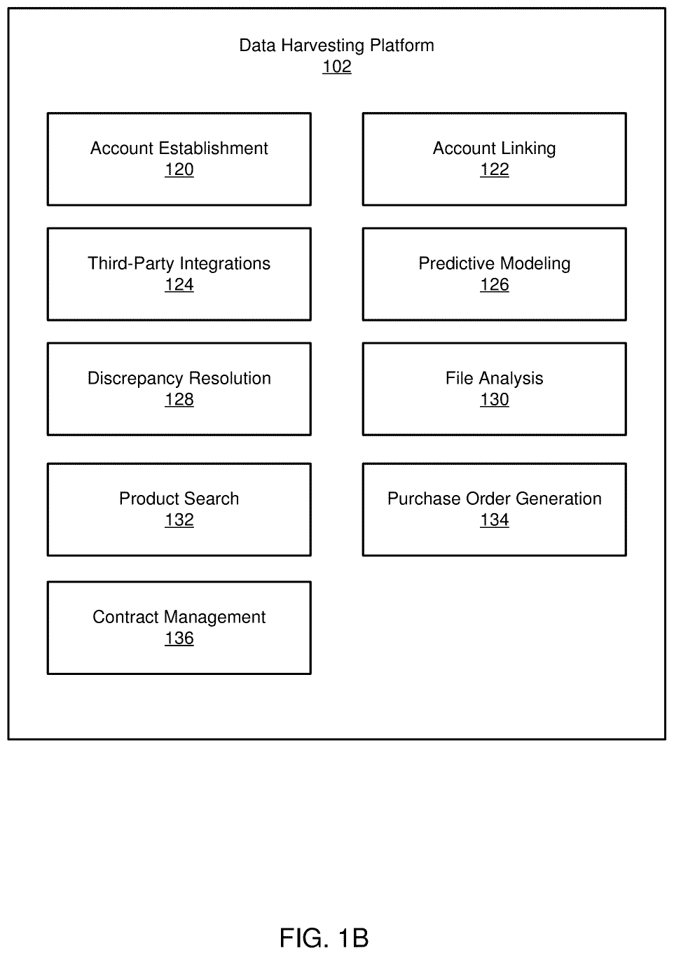

Referring now to the figures, FIG. 1A is a schematic diagram of a system 100 for data harvesting and aggregation that can be implemented for increasing the efficiency of computing systems for scraping, ingesting, storing, and analyzing data. The system 100 includes a data harvesting platform 102 operated by a data harvesting server 104. The system 100 includes one or more communication devices 106 that receive and transmit information by way of the network 110. The system 100 includes an application datastore 112 for storing ingested data, training datasets, structured data, and unstructured data. In some implementations, the application datastore 112 communicates with a metadata store 114 and one or more data buckets 116. Each of the data harvesting server 104, the application datastore 112, and the communication devices 106 is in communication with a network 110 such as the Internet.

The data harvesting platform 102 is accessible by way of a user interface that may be rendered on an application or web interface. A user may access the data harvesting platform 102 to initiate data scraping or data harvesting processes. In most instances, a user will access the data harvesting platform 102 to initiate a request to execute a search for a certain product or service. The data harvesting platform 102 is operated by the data harvesting server 104, which is in communication with other entities and databases by way of Application Program Interfaces (APIs), Secure File Transfer Protocols (SFTP), or other connections by way of the network 110.

The communication devices 106 include personal computing devices that can communicate with the data harvesting server 104 by way of the network 110. The communication devices 106 may include, for example, mobile phones, laptops, personal computers, servers, server groups, tablets, image sensors, cameras, scanners, desktop computers, set-top boxes, gaming consoles, smart televisions, smart watches, fitness bands, optical head-mounted displays, virtual reality headsets, smart glasses, HDMI or other electronic display dongles, personal digital assistants, and/or another computing device comprising a processor (e.g., a central processing unit (CPU)), a processor core, image sensors, cameras, a field programmable gate array (FPGA), or other programmable logic, an application specific integrated circuit (ASIC), a controller, a microcontroller, and/or another semiconductor integrated circuit device, a volatile memory, and/or a non-volatile storage medium. The communication devices 106 may comprise processing resources for executing instructions stored in non-transitory computer readable storage media. These instructions may be incorporated in an application stored locally to the communication device 106, an application accessible on a web browser, and so forth. The application enables a user to access the user interface for the data harvesting platform 102 to check submissions, upload files, verify whether files are accurately uploaded, receive feedback from the artificial intelligence and/or machine learning (AI/ML) engine 118, and so forth.

In an embodiment, a user accesses an account associated with the data harvesting platform 102 by way of the communication device 106. The user may be assigned a security role and location access to as many, or few, entities as is required by the user's position. Security roles restrict what information and/or functionality the user can access. The data harvesting platform 102 may be accessible on a mobile phone application. In some implementations, the mobile phone application uses the camera and networking capabilities of the mobile phone to capture images and upload those images to the data harvesting server 104 and the AI/ML engine 118 for analysis. The data harvesting platform 102 may be accessible on a web interface, either by way of a URL or a web browser plugin.

The one or more vendor databases 108 are managed externally relative to the data harvesting server 104 and may specifically be managed and owned by vendors of certain products and services. The vendor databases 108 are repositories of information, datasets, images, structured data, and unstructured data. In some cases, the data harvesting server 104 establishes a direct communication line with vendor databases 108 by way of an Application Program Interface (API) over the network 110 connection. In most cases, the data harvesting server 104 harvests or extracts only public-facing information from websites publishing information stored on the vendor databases 108. In some cases, the data harvesting server 104 extracts the data by scraping public-facing websites. In most cases, these websites are managed by external servers and do not maintain a direct communication line with the data harvesting server 104.

The application datastore 112 is a repository of information, datasets, images, structured data, unstructured data, and training datasets for the AI/ML engine 118. The data harvesting server 104 may access the application datastore 112 by way of an Application Program Interface (API) over the network 110 connection. The API allows the data harvesting server 104 to receive automatic updates from the application datastore 112 as needed. In an embodiment, the application datastore 112 is integrated on the data harvesting server 104 and is not independent of the storage and processing resources dedicated to the data harvesting server 104.

Data stored in the remote or cloud storage, such as the application datastore 112, may include data, including images and related data, from many different entities, customers, locations, or the like. The stored data may be accessible to a classification system that includes a classification model, artificial intelligence and/or machine learning engine, or other machine learning algorithm.

In some implementations, each independent database instance within the application datastore 112 is partitioned into a plurality of tables. In an example implementation, the data harvesting platform 102 is used for managing purchasing orders and product acquisition for various projects implemented by different clients. Each client account may have separate tables for each project or purchase order. The different client accounts are assigned independent database instances, so there is no threat of crosstalk or sharing of project information between different client accounts.

In some implementations, the application datastore 112 includes and/or communicates with a metadata store 114 and a bucket 116. In various implementations, the metadata store 114 and the bucket 116 may be considered a component of the application datastore 112, and in other implementations, they may be separate database structures that operate independently of the application datastore 112. The metadata store 114 includes a listing of where information is stored on the application datastore 112. The metadata store 114 may specifically include tables storing metadata about non-structured files stored in the bucket 116, and the metadata store 114 may additionally include an indication of where those non-structured file can be located within the bucket 116. The bucket stores non-structured files such as videos, images, documents, PDFs, and other files.

The application datastore 112 may be structured as a relational database. In a relational database, files and data are stored with predefined relationships to one another. The files and data are organized as a set of tables with columns and rows, and tables are used to hold information about the objects to be represented in the application datastore 112.

The application datastore 112 may be structured as a directed graph file system (which may be referred to as a semantic file system). The directed graph file system structures data according to semantics and intent, rather than location. The directed graph file system allows data to be addressed by content (associative access).

The AI/ML engine 118 comprises storage and processing resources for executing a machine learning or artificial intelligence algorithm. The AI/ML engine 118 may include a deep learning convolutional neural network (CNN). The convolutional neural network is based on the shared weight architecture of convolution kernel or filters that slide along input features and provide translation equivalent responses known as feature maps. The AI/ML engine 118 may include one or more independent neural networks trained to implement different machine learning processes.

FIG. 1B is a schematic block diagram illustrating potential components of the data harvesting platform 102. The data harvesting platform 102 may include, for example, components and algorithms for account establishment 120, account linking 122, third-party integrations 124, predictive modeling 126, discrepancy resolution 128, file analysis 130, product search 132, and purchase order generation 134.

The account establishment 120 component is responsible for onboarding accounts within the data harvesting platform 102. Each account may be associated with a unique individual or entity. Different accounts will be assigned different permissions for accessing data stored on the application datastore 112. The accounts may include, for example, administrator accounts with broader permissions to read and write data, and the accounts may include limited user accounts with limited permissions. Depending on the implementation of the data harvesting platform 102, the accounts may be specialized for certain tasks. For example, when the data harvesting platform 102 is implemented for project management, the accounts may include purchase manager accounts capable of indicating which products must be purchased to execute a project and/or repair equipment used for the project.

The account establishment 120 component generates a new account to be associated with a unique project and/or connects an existing account with the unique project. The data harvesting platform 102 will permit an account to read and/or write data associated with the unique project only if the account has been formally associated with the unique project by the account establishment 120 component.

The account linking 122 component associates accounts with a unique project and associates various datapoints with one another as needed, as explained further below. The account linking 122 component identifies a storage component of the application datastore 112 (such as a table or grouping of tables) that are associated with the unique project. The account linking 122 component assigns permissions to the applicable accounts to access at least a portion of the data stored in the application datastore 112 for the unique project. The account linking 122 component may independently assign read and write permissions to data stored on the application datastore 112 for the unique project.

The account linking 122 component additionally links various datapoints together as needed. In an example implementation, the data harvesting platform 102 is used for managing various manufacturing or construction projects. In this implementation, it may be useful to link certain products to specific tasks, timelines, or equipment. In some cases, it is useful to list certain replacement products for repairing and upkeeping a specific piece of equipment used for a project.

The third-party integrations 124 component establishes secure connections with third-party data sources. The third-party integrations 124 component stores a listing of authorized machines, devices, and accounts (i.e., “whitelisted”). The data harvesting server 104 securely communicates with outside parties by way of secure API access points. The third-party integrations 124 component may be implemented to receive real-time updates from various external parties, such as vendor suppliers. In some cases, the data harvesting server 104 maintains a direct line of communication with a vendor's inventor by way of the secure API access point, rather than by crawling and scraping the vendor's website.

Additionally, in some implementations, the data harvesting platform 104 receives real-time sensor data output from equipment used by a client account. In an example implementation, a user wishes to acquire repair parts for a certain piece of equipment used for a job, such as heavy machinery or other equipment. In some cases, the equipment includes sensors and processors for automatically issuing notifications when certain parts must be replaced or will need to be replaced soon. In some implementations, the data harvesting server 104 maintains a direct line of communication with these equipment devices, and then automatically generates a purchase order and/or notification for a user indicating that certain parts need to be purchased for the equipment. The data harvesting server 104 may additionally automatically check pricing for the specific needed parts from multiple vendor inventories, and then notify the user of the best pricing for the needed parts. The predictive modeling 126 component analyzes data to identify trends applicable to projects and/or improves workflows executed by the data harvesting server 104. In an implementation, the data harvesting platform 102 presents a project to a machine learning algorithm trained to determine whether required equipment, tools, and supplies will need to be acquired and/or replaced to complete the project. Additionally, the predictive modeling 126 may predict whether certain products are likely to experience a shortage and/or price fluctuation based on external environmental or economic factors.

In an implementation, the predictive modeling 126 component is implemented based on the concept of feedforward. The neural comprehension model may take an input of vectorized search terms, and then return distribution of probabilities based on a set of pre-collected user behavior categories. Refinery workers pre-process data inside of the infrastructures described herein to prime the data that will later be interpreted to satiate the requirements of the predictive modeling 126 component.

The predictive modeling 126 component may include an analysis of variance (ANOVA) statistical model. ANOVA is a collection of statistical models and their associated estimation procedures used to analyze the differences among means. ANOVA is based on the law of total variance, where the observed variance in a particular variable is partitioned into components attributable to different sources of variation.

The predictive modeling 126 component may include a long short-term memory (LSTM) artificial neural network architecture. LSTM is an artificial recurrent neural network. Unlike standard feedforward neural networks, LSTM has feedback connection. The LSTM architecture can process single data points (such as images) and can further process sequences of data (such as speech or video). The LSTM architecture includes a cell, an input gate, an output gate, and a forget gate. The cell remembers values over arbitrary time intervals and the three gates regulate the flow of information into and out of the cell.

The predictive modeling 126 may include a recurrent neural network (RNN) architecture. The RNN architecture may be particularly implemented for modeling upcoming procedures and predicting future item usage based on past procedures. The RNN architecture is a class of artificial neural networks where connections between nodes form a directed graph along a temporal sequence. This allows the RNN to exhibit temporal dynamic behavior. RNNs can use an internal state (memory) to process variable length sequences of inputs.

The discrepancy resolution 128 is responsible for identifying and resolving discrepancies or inconsistencies in data or systems. In an example use-case, the discrepancy resolution 128 component flags a potential error if a user has previously purchased a certain part for a project, and then later purchases a different but related part for the same project. The discrepancy resolution 128 operates by comparing data from different sources or sub-systems and identifying any inconsistencies or errors. The discrepancy resolution 128 may compare transaction data and identify discrepancies in prior purchase orders or part listings.

The file analysis 130 component analyzes files uploaded to the application datastore 112 to determine the information depicted in those files. The files may include images, scans, videos, renders of digital documents, digital signatures, and so forth. In an example implementation, a user uploads a prior purchase order for parts needed for a project, and the file analysis 130 reads the purchase order to identify which parts were purchased in the past. In a further example implementation, a user uploads a project schedule or project instructions that comprise a listing of required parts. The file analysis 130 component then reads the project schedule or instructions to identify which parts will be needed for the project.

The file analysis 130 component includes a neural network or machine learning algorithm configured to “read” a document and identify the information depicted in the document. The file analysis 130 component communicates with the discrepancy resolution 128 component to determine whether documents uploaded by an account are consistent with other data that has been manually-input or otherwise ingested for the account.

The product search 132 component executes product searches in response to user-initiated search requests and further in response to automated workflow triggers. The product search 132 is executed by one or more of an elastic search instance, scraper instance, a proxy network manager process, a proxy network endpoint. The product search 132 is assisted and executed by additional components, modules, and hardware as described herein.

In some implementations, the product search 132 is executed in response to a user-initiated search requests. The user-initiated search request may include a detailed keyword description of a product. The detailed keyword description may identify a certain manufacturer of the product if the product is brand or manufacturer specific. In other cases, the detailed keyword description of the product does not identify a brand or manufacturer when the product is brand or manufacturer agnostic. The data harvesting server 104 identifies a unique part attribute (which may include, for example, a model number or serial number) for the product in response to receiving the detailed keyword description of the product. In some cases, the data harvesting server 104 identifies multiple suitable unique part attributes for the product, which may include, for example, a unique part number, a unique model number, a unique descriptor, and so forth. In many cases, the unique part attribute include a part number or model number. The data harvesting platform 102 may present the multiple potential unique part attributes for the product, along with images and/or associated descriptions, to the user, and thereby enable the user to indicate which of the part attributes is applicable.

The product search 132 may be executed in response to a user-initiated request that identifies a certain unique part attribute. This type of user-initiated request may include a listing of parts to be acquired for a project or a listing of parts for repairing or maintaining a certain piece of machinery or equipment. In some cases, the unique part attribute is a unique part number, and typically, the unique part number is tied to a certain manufacturer. In some cases, the user will request that two or more unique part attributes be searched simultaneously. This may occur when two or more manufacturers make suitable parts that each have their own unique part attributes but are functionally interchangeable from the user's perspective.

The product search 132 may be executed in response to a workflow trigger. In some cases, a user may manually input a workflow trigger indicating, for example, that a certain quantity of a certain product needs to be purchased at regular intervals. The user may indicate that certain machinery is malfunctioning, and then the data harvesting server 104 may propose which parts may need to be acquired to repair the machinery. The user may upload manufacturer recommendations for regular maintenance and upkeep of applicable machinery. The user may connect the data harvesting server 104 with sensors or processors associated with machinery and enable the machinery to automatically communicate with the data harvesting server 104 when certain parts need to be replaced or repaired. Each of these events may initiate a workflow trigger that causes the data harvesting server 104 to automatically search for applicable products, and then provide the user with a search report indicating the real-time availability and pricing for one or more products that should be acquired.

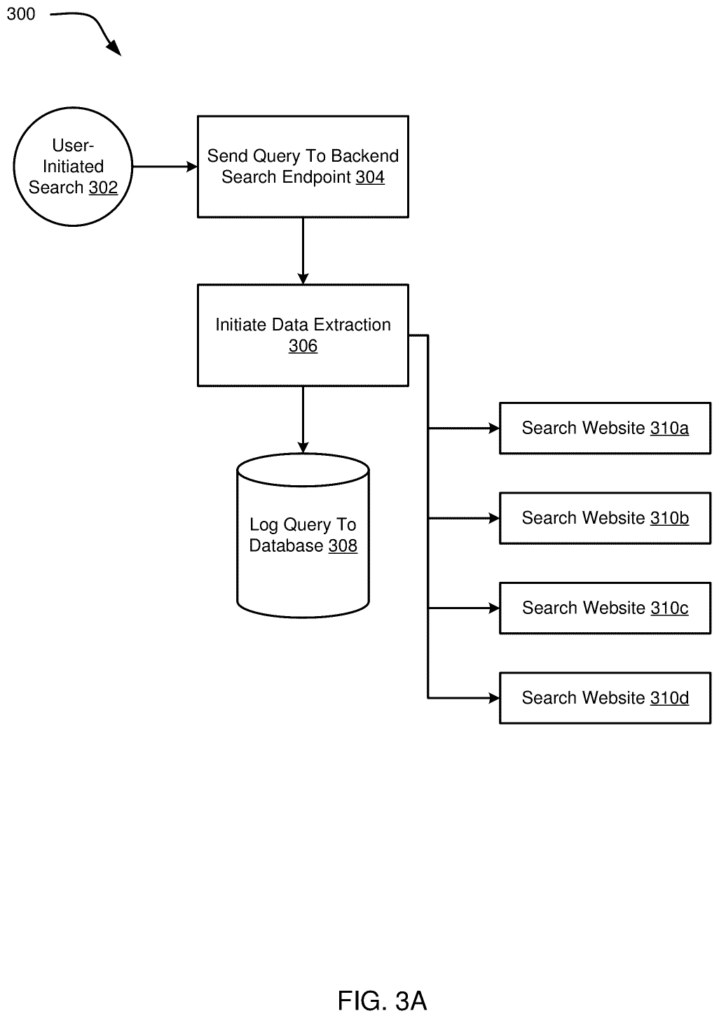

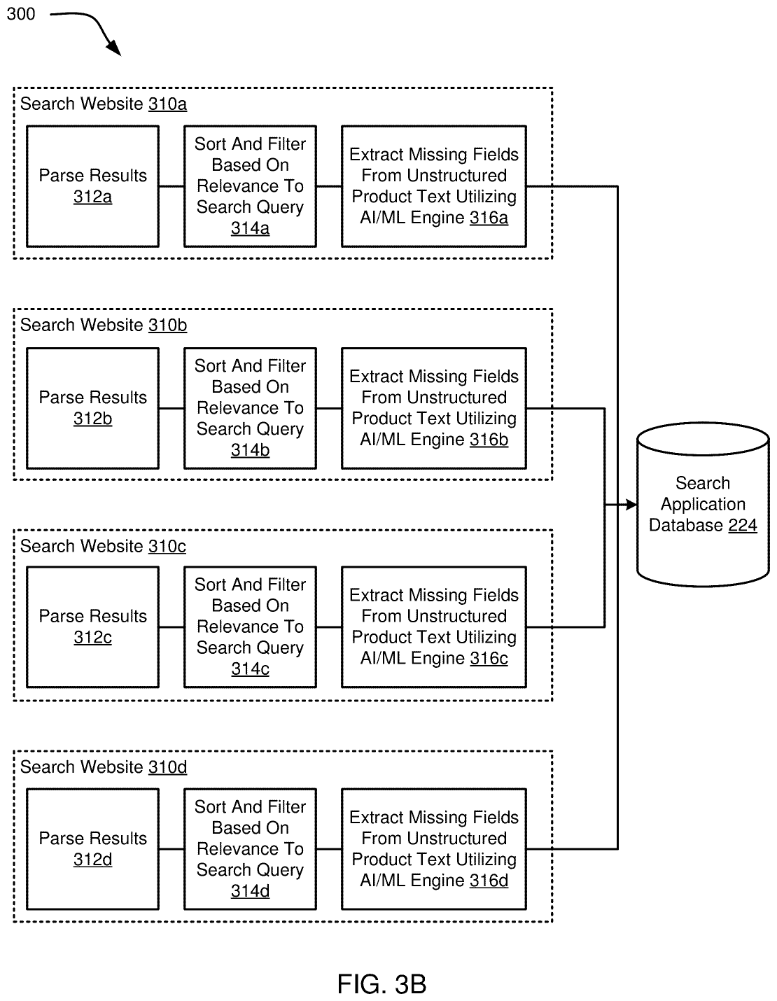

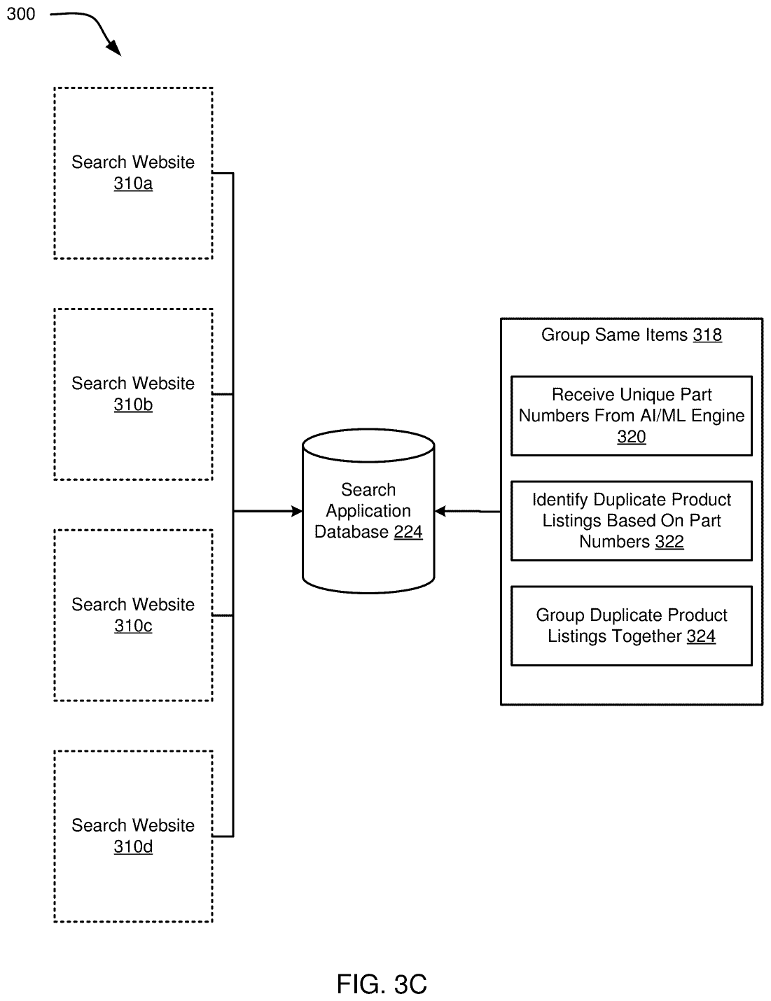

The purchase order generation 134 component generates a search report and/or purchase order in response to executing a specialized search for a product comprising a unique part attribute, such as a unique part number, model number, serial number, and so forth. The specialized search is executed using data scraping methods as described herein and may specifically be executed according to the process flow described in connection with FIG. 3. The data harvesting server 104 may then automatically generate a purchase order and/or fill a virtual shopping cart with one or more vendors supplying the necessary products.

The contract management 136 component tracks negotiated pricing between a user and one or more vendors. In some cases, the contract management 136 component receives information output by the file analysis 130 component. This may occur in response to a user uploading a contract document such as a scan of a printed contract, a pdf of a digital contract, a term sheet for a contract, and so forth. The file analysis 130 component then automatically identifies the contract terms and the negotiated pricing for various products. The contract management 136 component saves the negotiated pricing for the applicable products and the applicable vendors.

The contract management 136 component ensures that negotiated pricing is reflected in search reports, proposed purchase orders, and virtual shopping carts with various vendors. In an example implementation, the data harvesting server 104 provides a search report to a user that lists the availability and pricing for acquiring a certain product (having a unique part attribute) from a plurality of different vendors. The contract management 136 component determines whether the user has special negotiated pricing for the product with any of the plurality of vendors. If the user has negotiated pricing with a certain vendor, then the negotiated price (rather than the public list price) of the product will be reflected in the search report.

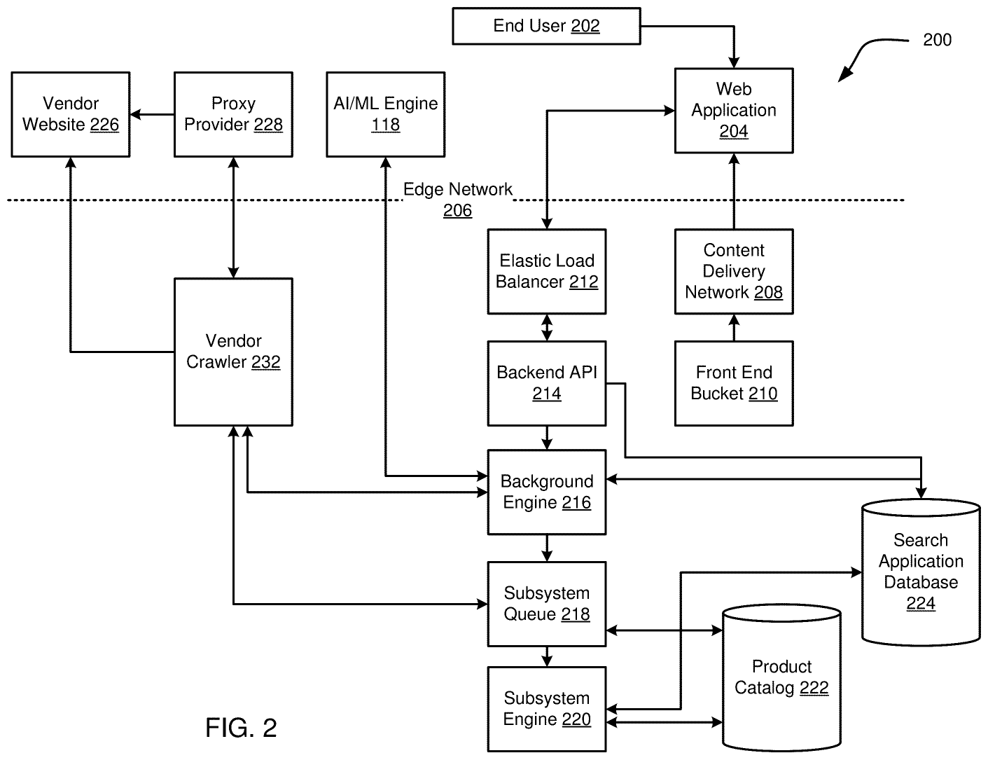

FIG. 2 is a schematic block diagram of a system 200 for executing the data harvesting and data aggregation methods described herein. The components of the system 200 are integrated within most components illustrated in FIG. 1A, namely, most modules within the system 200 are executed by the data harvesting server 104 and the AI/ML engine 118, and then rendered on the data harvesting platform 102.

The system 200 is configured to execute data scraping (also known as web scraping or data harvesting) to perform searches on specific products available across multiple vendors. The system 200 extracts data or information from websites and other sources on the Internet. The extracted data is used for data analysis, market research, and price monitoring, and may specifically be used to return real-time search responses to a user-initiated search for a specific product.

The processes performed by the system 200 are initiated by an end user 202. The end user 202 may engage directly with a user interface rendered on the data harvesting platform 102, which is run on a web application 204. The web application 204 may include an automatically scalable web application. The web application 204 is run on an edge network 206. The data storage is performed by a search application database 224 and a product catalog 222, which may be run as components of the data harvesting server 104 and/or other components of the system 100 first described in connection with FIG. 1A.

In response to receiving a search request form an end user 202, the web application 204 communicates with an elastic load balancer 212. The elastic load balancer 212 communicates with a backend application program interface (API) 214, which in turn communicates with a background engine 216. The background engine 216 communicates with a subsystem queue 218 run on a subsystem engine 220. The subsystem engine 220 and the subsystem queue 218 communicate with the product catalog 222. The subsystem engine 220, the background engine 216, and the backend API 214 communicate with the search application database 224.

The system 200 further includes the AI/ML engine 118 running on the edge network 206. The AI/ML engine 118 communicates with the background engine 216. The system 200 includes a proxy provider 228 and vendor website 226 that also run on the edge network 206 or communicate via the edge network 206. The proxy provider 228 communicates with the vendor website 226 and the vendor crawler 232. The vendor crawler 232 retrieves information from the vendor website 226. The vendor crawler 232 communicates with the background engine 216 and the subsystem queue 218.

The product catalog 222 and the search application database 224 store information pertaining to the searches initiated by the web application 204.

The web application 204 runs on the edge network 206 and receives inputs from the end user 202. The web application 204 is capable of handling growing amounts of work through vertical and horizontal scalability. The web application 204 is vertically scalable through adding or upgrading server resources, such as CPU, RAM, or storage capacity, to handle and manage increased load. The web application 204 is horizontally scalable through adding additional servers or database instances to distribute load across multiple machines.

The content delivery network 208 delivers static and dynamic web content. The content delivery network 208 may specifically include a service such as Amazon CloudFront® or other comparable service. The content delivery network 208 operates through a network of edge locations strategically located around the world and allows cache copies of content to be closer to end users 202 to reduce latency and improve performance. The content delivery network 208 automatically scales to handle and manage large amounts of traffic and ensure content is delivered reliably during traffic spikes and high demand.

The front end bucket 210 may be referred to as a front end deployment bucket or deployment pipeline. The front end bucket 210 is a storage resource on a cloud service provider. The front end bucket 210 stores static assets such as HTML, CSS, JavaScript, images, and so forth, for the web application 204. These assets may be accessed through the web application 204.

The proxy provider 228 offers proxy servers for performing data scraping on the vendor websites 226. The proxy provider 228 extracts data from the vendor websites 226 and communicates with the vendor crawler 232. In some cases, the proxy provider 228 scrapes data from the vendor websites 226. The proxy provider 228 maintains a network of proxy servers located in different geographic locations, and these servers act as intermediaries between the end user 202 and the Internet. In some cases, data scraping processes are distributed across multiple IP addresses through use of the proxy provider 228.

The vendor crawler 232 communicates with the proxy provider 228 and may notify the proxy provider 228 when an update is made to a vendor website 226 and updated data should be extracted from the vendor website 226. The vendor crawler 232 is a software program designed to systematically browse and extract information from the vendor websites 226. The extracted information may include, for example, product listings, structured product data, unstructured product data, pricing data, availability data, specifications, and so forth. The vendor crawler 232 navigates through the vendor websites 226 to gather desired information. This process may involve scraping HTML content, parsing structured data like JSON or XML, and interacting with web forms and APIs to access data. When the vendor crawler 232 identifies relevant web pages, the vendor crawler 232 extracts information according to predefined rules or patterns. This may include extracting product names, descriptions, prices, images, product numbers, and other data points.

The data extracted by the vendor crawler 232 is provided to the background engine 216 and the subsystem queue 218. The data may then be stored on one or more of the search application database 224 or the product catalog 222. The vendor crawler 232 is configured to regularly revisit the vendor websites 226 to update the extracted information. The updated information is then stored on the search application database 224 and/or the product catalog 222.

The elastic load balancer 212 automatically distributes incoming traffic from the web application 204. The elastic load balancer 212 automatically distributes the incoming traffic across multiple targets, such as multiple containers, IP addresses, and so forth.

The backend API 214 allows different software applications to communicate with one another. The backend API 214 handles client-side applications for the web application 204 and performs operations on the server-side. These operations may include, for example, data retrieval, data storage, data manipulation, and data processing.

The background engine 216 communicates with the AI/ML engine 118. The background engine 216 is utilized to process large datasets and run batch jobs. The background engine 216 may receive extracted data from the vendor crawler and then cause that data to be transformed and loaded on to the search application database 224.

The subsystem queue 218 acts as a buffer for tasks or jobs that need to be processed by the background engine 216 or the subsystem engine 220. Tasks that will be performed by the subsystem engine 220 may first be queued within the subsystem queue 218.

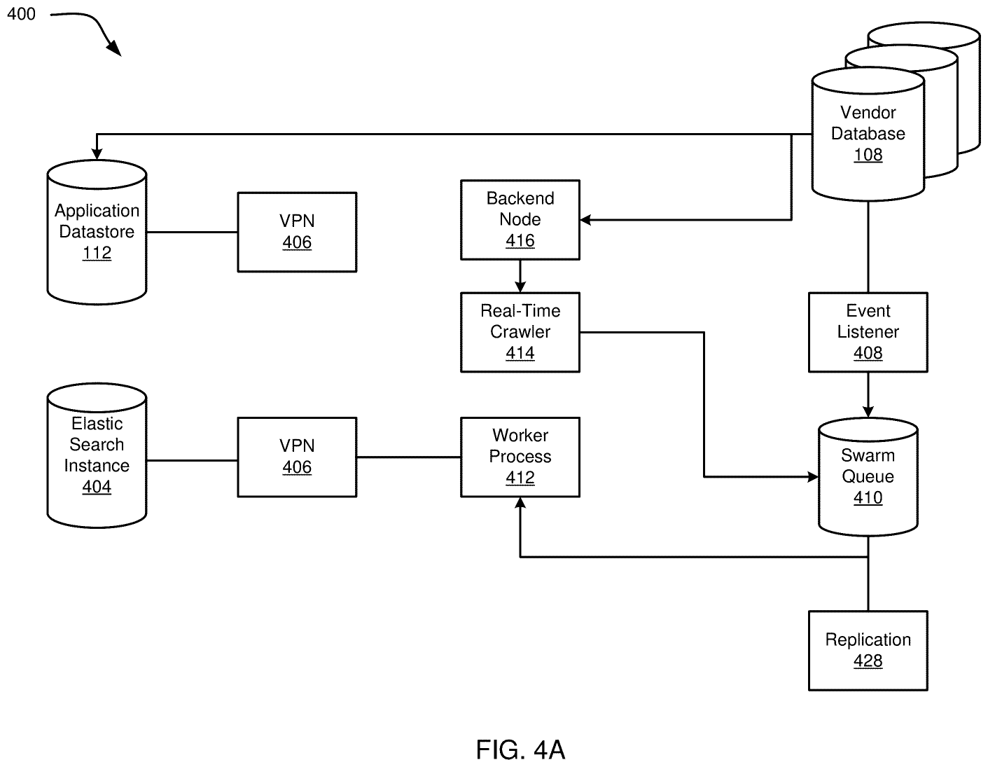

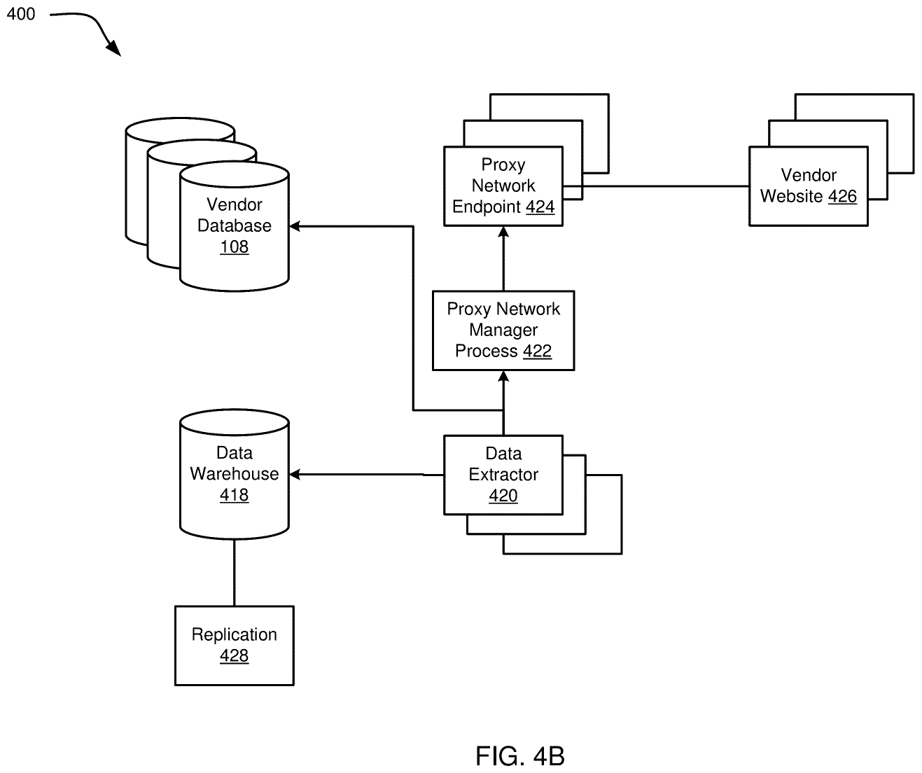

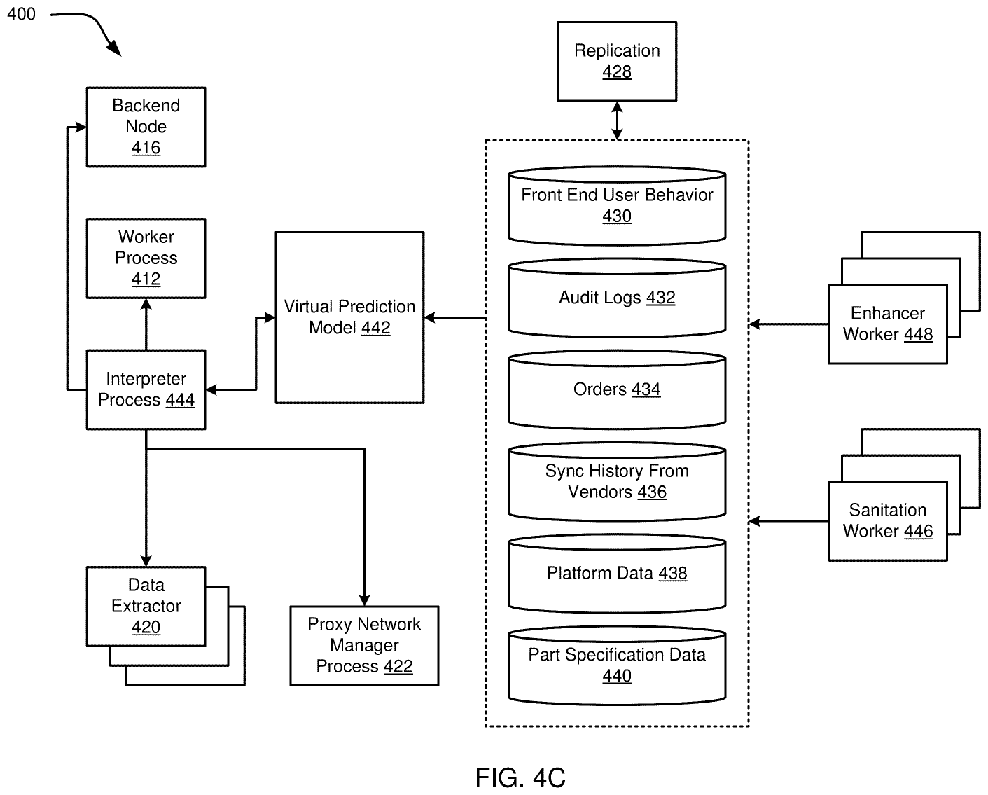

FIGS. 3A-3C are schematic block diagrams of a process flow 300 for executing a real-time multiple-vendor search request. The process flow 300 may be executed by the components of the systems described herein, including components of the system 100 first described in connection with FIG. 1, the system 200 first described in connection with FIG. 2, and/or the system 400 first described in connection with FIGS. 4A-4C.

The process flow 300 begins at FIG. 3A with a user-initiated search 302. The user-initiated search 302 may be submitted by an end user 202 to the web application 204. Upon receiving the user-initiated search 302, the user's query is sent to a backend search endpoint 304. The backend search endpoint may include the background engine 216, and the search may be queued within the subsystem queue 218 prior to being executed by the subsystem engine 220. The process flow 300 includes initiating data extraction 306. The data extraction process includes searching numerous vendor websites at 310a, 310b, 310c, 310d. The number of vendor websites (see 226 at FIG. 2) will depend on the type of search initiated by the end user. It should be appreciated that the number of vendor websites will depend on the implementation and particular use-case and may change from time to time. The user-initiated search 302 is further logged on to a database at 308.

The process flow 300 continues at FIG. 3B, which illustrates details pertaining to website searches 310a-310d performed on the various vendor websites 226. The process of searching a website includes parsing the results 312a-312d, sorting and filtering the results based on relevance to the search query 314a-314d, and extracting missing fields from unstructured product text utilizing the AI/ML engine 316a-316d. The product results are stored on the search application database 224.

The process flow 300 continues at FIG. 3C, which indicates that the product results stored on the search application database 224 will be grouped into product groupings at 318. Each of the product groupings includes the same items. This includes receiving at 320 unique part attributes from the AI/ML engine 118. The AI/ML engine 118 is trained to process data extracted from product listings and identify the part attribute within the extracted data. The AI/ML engine 118 identifies the part attribute for each product listing, and then duplicate products are identified at 322 based on the part attributes. Duplicate product listings are then grouped together at 324 into product groupings.

FIGS. 4A-4C are schematic block diagrams of an example system 400 for executing the data harvesting and aggregation methods described herein. The components of the system 400 illustrated in FIGS. 4A-4C are integrated within most components illustrated in FIG. 1A, namely, most modules within the system 400 are executed by the data harvesting server 104 and results are rendered on the data harvesting platform 102.

As shown in FIG. 4A, the system 400 includes the application datastore 112 and an elastic search instance 404. Each of the application datastore 112 and the elastic search instance 404 communicates by way of a Virtual Private Network (VPN) 406. The application datastore 112 retrieves information from a vendor database 108, which may include a plurality of database instances. The system 400 includes an event listener module 408 that retrieves information from the vendor database 108 and provides that information to a swarm queue 410. The system 400 includes a backend node 416 in communication with a real time crawler 414, and the real-time crawler 414 is additionally in communication with the swarm queue 410. The system 400 includes a worker process module 412 that receives information from the swarm queue 410. Data stored on the swarm queue 410 may be replicated by a replication module 428.

As shown in FIG. 4B, the system 400 further includes a data warehouse 418 a data extractor module 420 in communication with the vendor database 108. Like the swarm queue 410, the data warehouse 418 may further be replicated by a replication module 428. The data extractor module 420 communicates with a proxy network manager process 422, which further communicates with a proxy network endpoint 424. The proxy network endpoint 424 communicates with one or more vendor websites 426.

As shown in FIG. 4C, the backend node 416 of the system further communicates with an interpreter process 444, which is in communication with the data extractor module 420 and the proxy network manager process 422. The interpreter process 444 communicates with a worker process 412 and a virtual prediction model 442. The virtual prediction model 442 retrieves information from one or more databases, including, for example, databases for storing front end user behavior 430, audit logs 432, orders 434, sync history from vendors 436, platform data 438, and part specification data 440. The system 400 includes one or more enhance workers 448 and sanitation workers 446 that monitor, organize, and improve data stored on the plurality of databases 430-440.

The real-time crawler module 414 is configured to crawl certain vendor websites and consistently scrape data from those vendor websites. The real-time crawler 414 is a software program that automatically scans and indexes web pages on the Internet. The real-time crawler 414 begins by visiting a seed URL (uniform resource locator), which is the starting point for its search. The seed URL may include a homepage, sitemap, or another web page. The real-time crawler 414 analyzes the content of the seed URL and extracts links found on that page. The real-time crawler 414 then follows each of those links to new pages and extracts additional links it finds on those pages. The process of visiting new pages and extracting links continues recursively, creating a web of interconnected pages. As the real-time crawler 414 visits each pages, it downloads and stores a copy of the page's content, including text, images, and other media. The real-time crawler 414 may also analyze the content of each page to extract useful information, such as keywords or metadata. Once the real-time crawler 414 has scanned a sufficient number of pages or has reached a predetermined limit, it stops and the collected data is indexed and added to a search engine database, which may specifically include the swarm queue 410. The real-time crawler 414 is used to monitor certain websites for changes and collect data for producing a robust product search engine.

The event listener module 408 is a programming construct that waits for a specific event to occur and then executes a function or a set of instructions in response to that event. The event listener 408 may be assigned to an element on a webpage, such as a button, a link, or a form field. The event listener 408 waits for a specific event to occur on that element, such as an adjustment to a product price, and then triggers a workflow based on the event. The event listener 408 may store its findings in the swarm queue 410.

The swarm queue 410 is a task queue where tasks are distributed across multiple nodes or machines, with the goal of efficiently and reliably processing large amounts of data or workloads. The swarm queue 410 provides a means to distribute and manage workload across multiple processing and storage resources within the system 400. The swarm queue 410 is fault-tolerant and scalable.

The data warehouse 418 is a data warehousing system designed to facilitate querying and managing large datasets. The data warehouse 418 stores data in tables, which can be organized into databases. The data warehouse 418 can improve query performance and make it easier to manage large datasets.

The data extractor 420 module is a software program or script that automates the process of extracting data or information from websites. The data extractor 420 uses multiple techniques to extract data, including web crawling, data parsing, and data extraction. The data extractor 420 is specifically used to extract product information from vendor websites. The system 400 includes a separate data extractor 420 instance for each vendor website 426 being monitored.

The data extractor 420 communicates with the proxy network manager process 422, which in turn communicates with the proxy network endpoint 424. The proxy network is a container image distribution system that manages container images and the distribution of those images across a cluster of nodes. The proxy network manager process 422 runs on each node in the cluster and is responsible for several tasks, including image management, image distribution, image caching, and node management. For image management, the proxy network manager 422 manages the storage and retrieval of container images, thus ensuring the images are available to be pulled by containers running on the node. For image distribution, the proxy network manager 422 coordinates the distribution of container images across the cluster, ensuring that each node has a copy of the necessary images. For image caching, the proxy network manager 422 caches container images on each node, thus reducing the time required to pull images. For node management, the proxy network manager 422 monitors the status of each node in the cluster.

The virtual prediction model 442 may include a machine learning algorithm such as the AI/ML engine 118 configured to predict future searches that will be requested by users of the system 400. The virtual prediction model 442 requests future searches based on, for example, front end user behavior 430, audit logs 432, orders 434, sync history from vendors 436, platform data 438, and part specification data 440.

The enhancer workers 448 are implemented within the distributed comping system 400 to enhance performance of a task or set of tasks by offloading the computing to a worker node. In the distributed computing system 400, sets of tasks are divided into smaller sub-tasks and distributed among worker nodes to be executed in parallel. The enhancer workers 448 are a specific type of worker node that is designed to enhance the performance of certain tasks, such as data processing or machine learning, by providing additional computational resources. The enhancer workers 448 may specifically be implemented to train the AI/ML engine 118 to execute the virtual prediction model 442 algorithm. This is a computationally intensive task, and by offloading this task to the enhancer workers 448, the overall performance of the system 400 is improved.

The sanitation workers 446 are responsible for data garbage collection to filter out unnecessary data across the system. The sanitation workers 446 parse errors by the real-time crawlers 414 based on data output, and then adjust a data schema and pre-processed data to conform to the product scheme. The sanitation workers 446 sanitize malformed data inputs so the remaining infrastructure can focus on harvesting and processing data. The sanitation workers 446 are configured to comb through and adjust data as needed by performing scans on harvested HTML from the real-time crawlers 414 to look for undetected data entities not conforming to expected HTML specifications for each vendor.

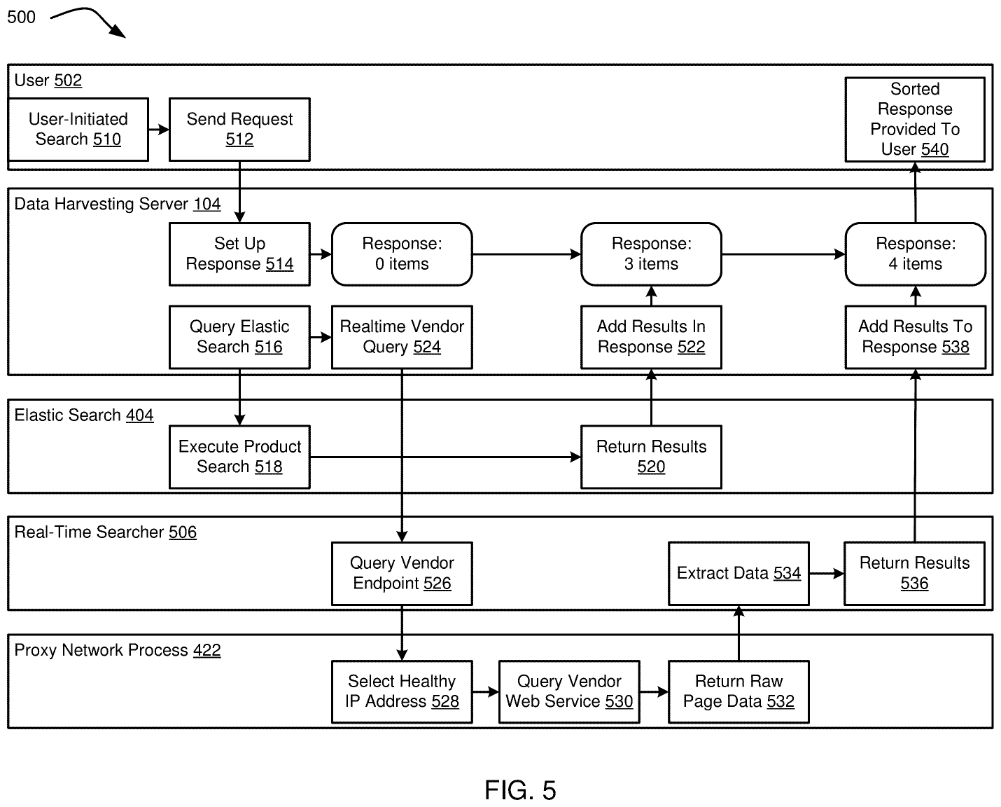

FIG. 5 is a schematic flow chart diagram of a process flow 500 for executing a specialized product search across multiple vendor websites. The process flow 500 may be executed by one or more of the components of the systems described herein, including one or more of the components of the system 100 first described in connection with FIG. 1, the system 200 first described in connection with FIG. 2, and/or the system 400 first described in connection with FIGS. 4A-4C.

The process flow 500 begins and a user 502 inputs a user-initiated search 510. The user 502 causes the search request to be sent at 512 to the data harvesting server 104, which includes the system components described in connection with one or more of FIG. 2 or FIGS. 4A-4C. The data harvesting server 104 sets up a response to request at 514, and at this time, the response includes zero items. The data harvesting server 104 queries the elastic search instance 404 at 516. The elastic search instance 404 then executes the product search at 518 and returns the results at 520. The results are provided to the data harvesting server 104, and then the data harvesting server 104 adds the results to the response at 522. At this time, the example response now includes three items.

The data harvesting server 104 further provides a query vendor endpoint at 526 to the real-time searcher 506. The real-time searcher 506 provides the vendor endpoint to the proxy network process 422, and the proxy network process 422 selects a healthy IP address at 528, and then queries the vendor web service at 530, and then returns the raw page data at 532. The real-time searcher 506 then extracts the data at 534 and returns the results at 536. The data harvesting server 104 receives the results and then adds the results to the response at 538. At this time, the example response now include four items.

The data harvesting server 104 then sorts the results based on user criteria. In most cases, the data harvesting server 104 will sort the results based on price and then refine the results based on user specifications. The data harvesting server 104 returns the result to the user at 540 by rendering the result on the data harvesting platform 102.

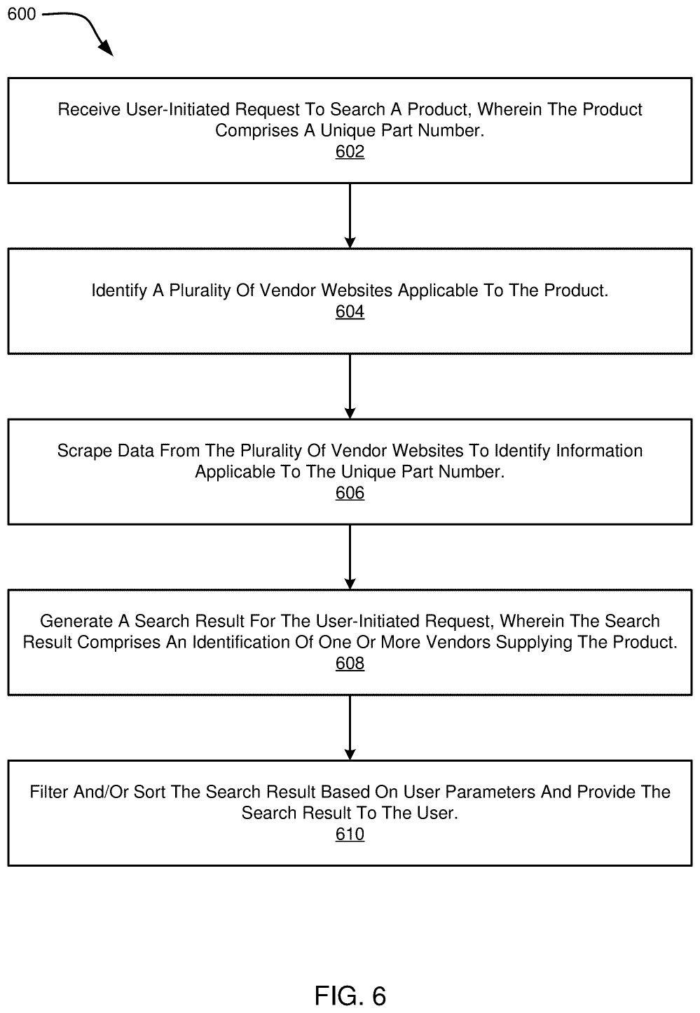

FIG. 6 is a schematic flow chart diagram of a method 600 for generating a search result for a product in response to receiving a user-initiated request. The method 600 is performed by the data harvesting server 104 and/or components in communication with the data harvesting server 104. The method 600 may specifically be performed by one or more of the components of the systems described herein, including one or more of the components of the system 100 first described in connection with FIG. 1, the system 200 first described in connection with FIG. 2, and/or the system 400 first described in connection with FIGS. 4A-4C.

The method 600 includes receiving at 602 a user-initiated request to search a product, wherein the product comprises a unique part attribute. The user-initiated request may be input by way of a user interface rendered on the data harvesting platform 102, and then provided to the data harvesting server 104. The user-initiated request may include a description of a product or an identification of a unique part attribute for the product.

In an example use-case, the user-initiated request comprises a detailed description of a product such as, for example, “one inch liquid-tight connector.” This product will have unique part attributes associated with various brands, but may be considered “manufacturer-agnostic,” meaning the product could be acquired from various manufacturers or brands without suffering a loss in quality or efficacy. In this use-case, the data harvesting server 104 is configured to identify one or more manufactures that supply the “one inch liquid-tight connector” and further identify a unique part attribute associated with the product from each of the one or more manufacturers. Thus, in this use-case, the singular product may be associated with a plurality of unique part numbers, because manufacturer will supply a different unique part number for the matching product.

In a different example use-case, the user-initiated request comprises the unique part number and may additionally comprise an indication of the manufacturer or brand associated with the unique part number. In this use-case, the data harvesting server 104 determines that the only acceptable product is one manufactured by the identified manufacturer and having the identified part number. In some instances, the user provides only the unique part number and does not identify which manufacturer is associated with the unique part number. In these cases, the data harvesting server 104 searches the unique part number and attempts to identify which brand or manufacturer is associated with the unique part number. The data harvesting platform 102 will provide these search results to the user and invite the user to indicate which of the potential parts/manufacturers is correct.

The method 600 continues with identifying at 604 a plurality of vendor websites applicable to the product. The method 600 continues with scraping data at 606 from each of the plurality of vendor websites to identify information applicable to the unique part number. The method 600 includes generating at 608 a search result for the user-initiated request, wherein the search result comprises an identification of one or more vendors supplying the product having the unique part number. The method 600 includes filtering and/or sorting at 610 the search result based on user parameters, and then providing the search result to the user.

In most cases, the search result will comprise a listing of vendors where the product comprising the unique part number can be acquired. The search result will also include an indication of real-time pricing for the product from each of the vendors, along with associated shipping and processing costs. The search result may be sorted based on price such that the least expensive option is displayed first. In some cases, the displayed pricing factors in unique contracts between the user and the various vendors. The search result will indicate when the products may be acquired from each of the vendors, including whether the products may be picked up locally or will be shipped.

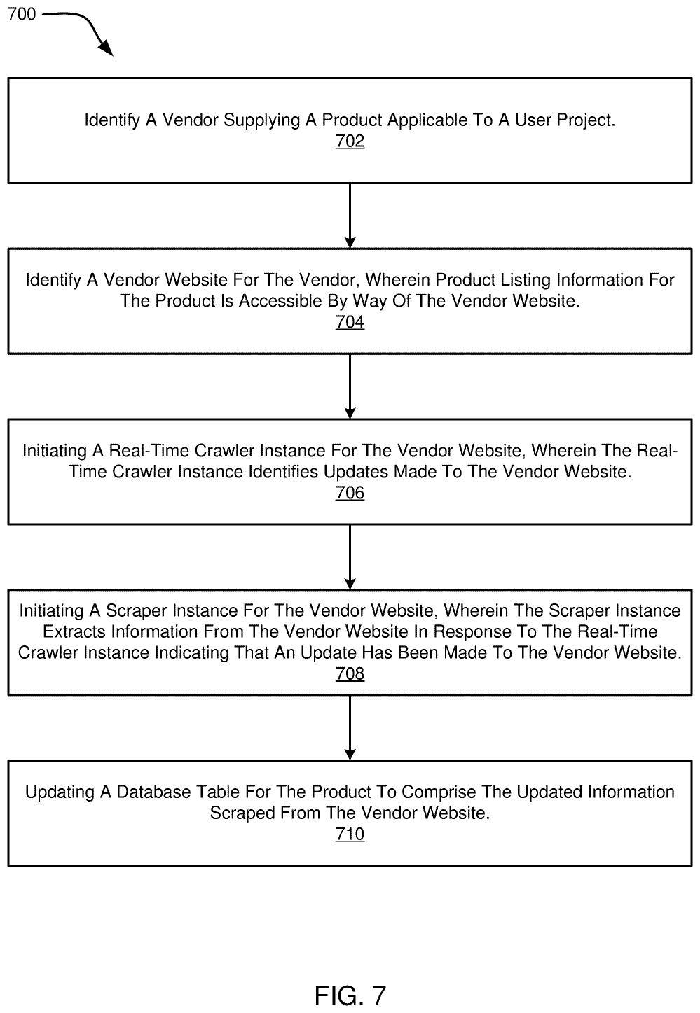

FIG. 7 is a schematic flow chart diagram of a method 700 for generating a search result for a product in response to receiving a user-initiated request. The method 700 is performed by the data harvesting server 104 and/or components in communication with the data harvesting server 104. The method 700 may specifically be performed by one or more of the components of the systems described herein, including one or more of the components of the system 100 first described in connection with FIG. 1, the system 200 first described in connection with FIG. 2, and/or the system 400 first described in connection with FIGS. 4A-4C.

The method 700 includes identifying at 702 a vendor supplying a product applicable to a user project. The data harvesting server 104 may automatically identify one or more products and/or unique part numbers associated with the user project based on parameters for the user project. The data harvesting server 104 may store a listing of products and/or unique part numbers that must be acquired for the project in response to a user manually inputting the products and/or unique part numbers.

The method 700 continues with identifying at 704 a vendor website for the vendor, wherein product listing information for the product is accessible by way of the vendor website. The method 700 includes initiating at 706 a real-time crawler instance for the vendor website, wherein the real-time crawler instance identifies updates made to the vendor website. The method 700 includes initiating at 708 a scraper instance for the vendor website, wherein the scraper instance extracts information from the vendor website in response to the real-time crawler instance indicating that an update has been made to the vendor website. The method 700 includes updating at 710 a database table for the product to comprise the updated information scraped from the vendor website. The updated information may include, for example, real-time availability or pricing information for the product.

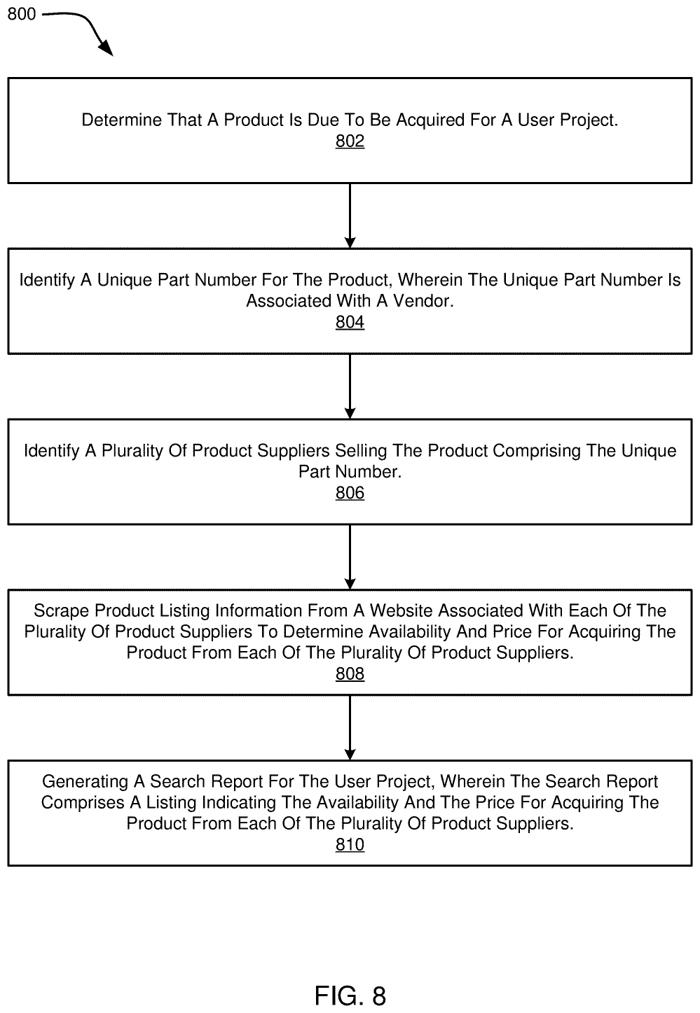

FIG. 8 is a schematic flow chart diagram of a method 800 for generating a search result for a product in response to receiving a user-initiated request. The method 800 is performed by the data harvesting server 104 and/or components in communication with the data harvesting server 104. The method 800 may specifically be performed by one or more of the components of the systems described herein, including one or more of the components of the system 100 first described in connection with FIG. 1, the system 200 first described in connection with FIG. 2, and/or the system 400 first described in connection with FIGS. 4A-4C.

The method 800 begins with determining at 802 that a product is due to be acquired for a user project. The user project may be manually or automatically input to the data harvesting server 104, and the data harvesting server 104 may automatically determine if a certain product is due to be acquired for the project. In an example use-case, the project identifies machinery that will inevitably need to be repaired or replaced on a certain timeline, and the data harvesting platform 104 may automatically determine that a certain part should be acquired to repair or replace the machinery.

The method 800 continues with identifying at 804 a unique part number for the product, wherein the unique part number is associated with a vendor. The method 800 includes identifying at 806 a plurality of product suppliers selling the product comprising the unique part number. The method 800 includes scraping at 808 product listing information from a website associated with each of the plurality of product suppliers to determine availability and price for acquiring the product from each of the plurality of product suppliers. The method 800 includes generating at 810 a search report for the user project, wherein the search report comprises a listing indicating the availability and the price for acquiring the product from each of the plurality of product suppliers.

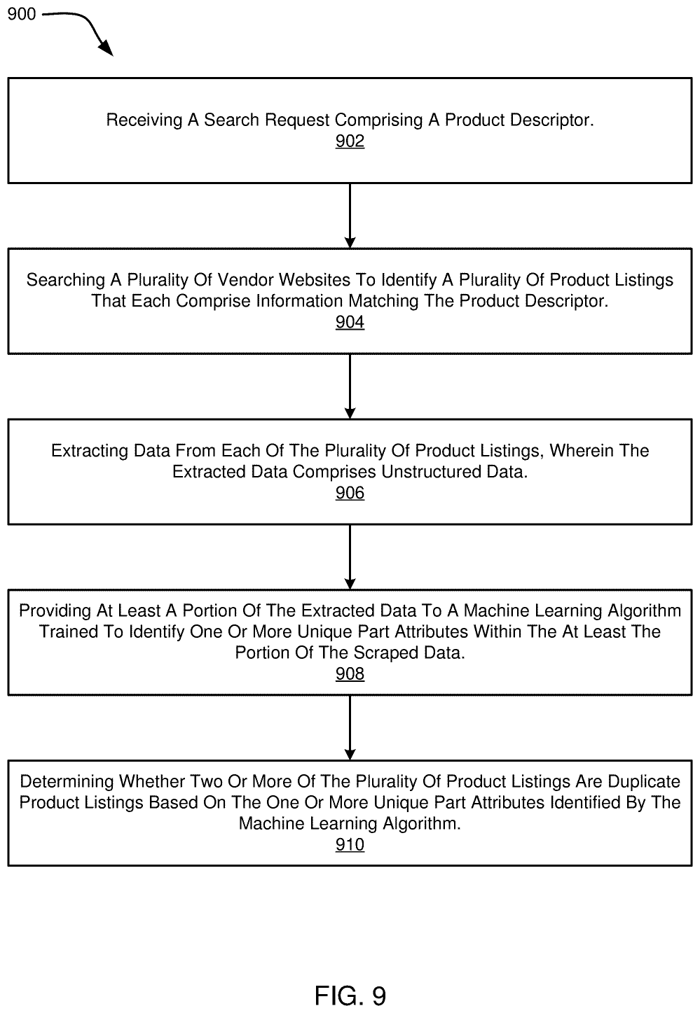

FIG. 9 is a schematic flow chart diagram of a method 900 for generating a search result for a product in response to receiving a user-initiated request. The method 900 is performed by the data harvesting server 104 and/or components in communication with the data harvesting server 104. The method 900 may specifically be performed by one or more of the components of the systems described herein, including one or more of the components of the system 100 first described in connection with FIG. 1, the system 200 first described in connection with FIG. 2, and/or the system 400 first described in connection with FIGS. 4A-4C.

The method 900 includes receiving at 902 a search request comprising a product descriptor. The search request may be received from an end user interacting with a scalable web application supporting the data harvesting platform 102. The search request includes a product descriptor, which may include one or more of a keyword description of a product, a description of a supplier or manufacturer, a product part number, SKU, or model number, an image of a product, and so forth.

The method 900 includes searching at 904 a plurality of vendor websites to identify a plurality of product listings that each comprise information matching the product descriptor. The information matching the product descriptor could be, for example, a matching product part number, SKU, or model number, a title keyword matching a product descriptor keyword, a matching product supplier, a matching product manufacturer, a matching product specification, and so forth.

The method 900 includes scraping at 906 data from each of the plurality of product listings, wherein the extracted data comprises unstructured data. The method 900 includes providing at 908 at least a portion of the extracted data to a machine learning algorithm trained to identify one or more unique part attributes within the portion of the extracted data. The method 900 includes determining at 910 whether two or more of the plurality of product listings are duplicate product listings based on the one or more unique part attributes identified by the machine learning algorithm.

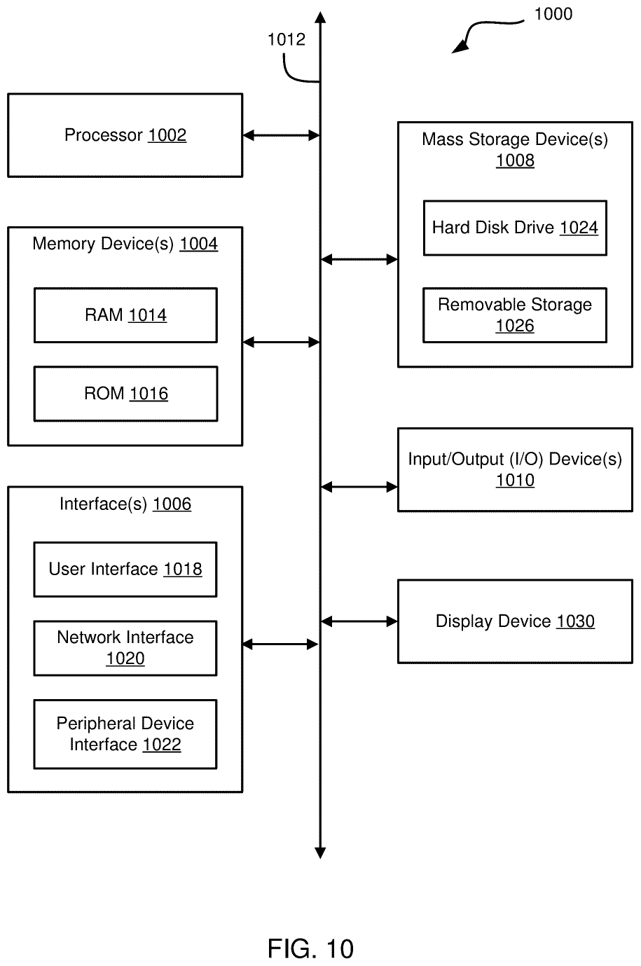

Referring now to FIG. 10, a block diagram of an example computing device 1000 is illustrated. Computing device 1000 may be used to perform various procedures, such as those discussed herein. Computing device 1000 can perform various monitoring functions as discussed herein, and can execute one or more application programs, such as the application programs or functionality described herein. Computing device 1000 can be any of a wide variety of computing devices, such as a desktop computer, in-dash computer, vehicle control system, a notebook computer, a server computer, a handheld computer, tablet computer and the like.

Computing device 1000 includes one or more processor(s) 1002, one or more memory device(s) 1004, one or more interface(s) 1006, one or more mass storage device(s) 1008, one or more Input/output (I/O) device(s) 1010, and a display device 1030 all of which are coupled to a bus 1012. Processor(s) 1002 include one or more processors or controllers that execute instructions stored in memory device(s) 1004 and/or mass storage device(s) 1008. Processor(s) 1002 may also include various types of computer-readable media, such as cache memory.

Memory device(s) 1004 include various computer-readable media, such as volatile memory (e.g., random access memory (RAM) 1014) and/or nonvolatile memory (e.g., read-only memory (ROM) 1016). Memory device(s) 1004 may also include rewritable ROM, such as Flash memory.

Mass storage device(s) 1008 include various computer readable media, such as magnetic tapes, magnetic disks, optical disks, solid-state memory (e.g., Flash memory), and so forth. As shown in FIG. 10, a particular mass storage device 1008 is a hard disk drive 1024. Various drives may also be included in mass storage device(s) 1008 to enable reading from and/or writing to the various computer readable media. Mass storage device(s) 1008 include removable media 1026 and/or non-removable media.

I/O device(s) 1010 include various devices that allow data and/or other information to be input to or retrieved from computing device 1000. Example I/O device(s) 1010 include cursor control devices, keyboards, keypads, microphones, monitors or other display devices, speakers, printers, network interface cards, modems, barcode scanners, and the like.

Display device 1030 includes any type of device capable of displaying information to one or more users of computing device 1000. Examples of display device 1030 include a monitor, display terminal, video projection device, and the like.

Interface(s) 1006 include various interfaces that allow computing device 1000 to interact with other systems, devices, or computing environments. Example interface(s) 1006 may include any number of different network interfaces 1020, such as interfaces to local area networks (LANs), wide area networks (WANs), wireless networks, and the Internet. Other interface(s) include user interface 1018 and peripheral device interface 1022. The interface(s) 1006 may also include one or more user interface elements 1018. The interface(s) 1006 may also include one or more peripheral interfaces 1022 such as interfaces for printers, pointing devices (mice, track pad, or any suitable user interface now known to those of ordinary skill in the field, or later discovered), keyboards, and the like.

Bus 1012 allows processor(s) 1002, memory device(s) 1004, interface(s) 1006, mass storage device(s) 1008, and I/O device(s) 1010 to communicate with one another, as well as other devices or components coupled to bus 1012. Bus 1012 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 900 and are executed by processor(s) 902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method. The method includes receiving a search request for a product. The method includes identifying a unique part attribute for the product. The method includes identifying a vendor website comprising a product listing for purchasing the product.

Example 2 is a method as in Example 1, further comprising scraping data from the product listing on the vendor website to determine whether the product is currently available from the vendor website.

Example 3 is a method as in any of Examples 1-2, further comprising scraping data from the product listing on the vendor website to determine real-time pricing for purchasing the product from the vendor website.

Example 4 is a method as in any of Examples 1-3, further comprising generating a search report for the search request, wherein the search result identifies one or more vendor websites wherein the product may be purchased.

Example 5 is a method as in any of Examples 1-4, wherein the search report indicates current availability and pricing for purchasing the product from each of the one or more vendor websites.

Example 6 is a method as in any of Examples 1-5, further comprising determining whether a user has negotiated pricing for the product with an identified vendor.

Example 7 is a method as in any of Examples 1-6, further comprising determining whether the negotiated pricing for the product with the identified vendor is currently available.

Example 8 is a method as in any of Examples 1-7, wherein the search report reflects the negotiated pricing for the product with the identified vendor.

Example 9 is a method as in any of Examples 1-8, further comprising sorting the one or more vendor websites identified in the search report by one or more of current availability, duration of shipping time, or price.

Example 10 is a method as in any of Examples 1-9, further comprising identifying the unique part attribute for the product.

Example 11 is a method as in any of Examples 1-10, wherein the unique part attribute is a model number or a serial number.

Example 12 is a method as in any of Examples 1-11, wherein the unique part attribute is specific to an identified manufacturer of the product.

Example 13 is a method as in any of Examples 1-12, wherein identifying the vendor website comprises executing a search to identify the vendor website offering the product having the unique part attribute.

Example 14 is a method as in any of Examples 1-13, further comprising initiating a real-time crawler instance for the vendor website, wherein the real-time crawler instance identifies updates made to the vendor website.

Example 15 is a method as in any of Examples 1-14, further comprising initiating a scraper instance for the vendor website, wherein the scraper instance extracts information from the vendor website.

Example 16 is a method as in any of Examples 1-15, wherein the scraper instance extracts the information from the vendor website in response to the real-time crawler instance indicating that an update has been made to the vendor website.

Example 17 is a method as in any of Examples 1-16, further comprising updating a database table for the product to comprise the updated information scraped from the vendor website.

Example 18 is a method as in any of Examples 1-17, wherein receiving the search request comprises receiving a workflow trigger indicating that the product should be acquired.

Example 19 is a method as in any of Examples 1-18, wherein the workflow trigger is configured to trigger after a certain duration of time has passed since the product was last acquired for a user.

Example 20 is a method as in any of Examples 1-19, wherein the workflow trigger is configured to trigger in response receiving a notification from a machinery sensor indicating the product should be replaced.

Example 21 is a method as in any of Examples 1-20, wherein the workflow trigger is configured to trigger in response to determining that a user's real-time inventory of the product has dropped below a threshold.

Example 22 is a method as in any of Examples 1-21, wherein receiving the search request for the product comprises receiving a user-initiated search request by way of a user interface.

Example 23 is a method as in any of Examples 1-22, further comprising identifying the unique part attribute for the product by executing a search for the product.

Example 24 is a method as in any of Examples 1-23, wherein identifying the unique part attribute comprises identifying a manufacturer-specific serial number for the product from one or more manufacturers producing qualifying products.

Example 25 is a method as in any of Examples 1-24, further comprising identifying a plurality of product suppliers selling the product comprising the unique part attribute.

Example 26 is a method as in any of Examples 1-25, further comprising scraping product listing information from a website associated with each of the plurality of product suppliers to determine availability and price for acquiring the product from each of the plurality of product suppliers.

Example 27 is a method as in any of Examples 1-26, further comprising generating a search report for the user project, wherein the search report comprises a listing indicating the availability and the price for acquiring the product from each of the plurality of product suppliers.

Example 28 is a method as in any of Examples 1-27, wherein the search report only comprises a listing of products having the exact unique part attribute.

Example 29 is a method as in any of Examples 1-28, wherein receiving the search request for the product comprises receiving the search request from a maintenance repair and operations (MRO) system.

Example 30 is a method as in any of Examples 1-29, further comprising automatically preparing a virtual shopping cart at the vendor website comprising a certain quantity of the product.

Example 31 is a method as in any of Examples 1-30, further comprising determining a quantity of the product to be acquired.

Example 32 is a method as in any of Examples 1-31, further comprising automatically generating a purchase order for acquiring the product from the vendor website, wherein the purchase order is formatted according to formatting constraints set by the vendor website.

Example 33 is a method as in any of Examples 1-32, further comprising automatically extracting real-time product information from a plurality of vendor websites selling the product and storing the real-time product information in a database.

Example 34 is a method as in any of Examples 1-33, further comprising executing a search in accordance with the search request by querying the database comprising the real-time product information for the plurality of vendor websites.

Example 35 is a method as in any of Examples 1-34, further comprising retrieving real-time availability and pricing information from a vendor by way of an application program interface (API).

Example 36 is a method. The method includes receiving a search request comprising a product descriptor. The method includes searching a plurality of vendor websites to identify a plurality of product listings that each comprise information matching the product descriptor. The method includes extracting data from each of the plurality of product listings, wherein the extracted data comprises unstructured data. The method includes providing at least a portion of the extracted data to a machine learning algorithm trained to identify one or more unique part attributes within the portion of the extracted data. The method includes determining whether two or more of the plurality of product listings are duplicate product listings based on the one or more unique part attributes identified by the machine learning algorithm.

Example 37 is a method as in Example 36, wherein receiving the search request comprises receiving an input from a user account associated with a scalable web application; and wherein the method further comprises determining whether the user account is associated with negotiated pricing at any of the plurality of vendor websites.

Example 38 is a method as in any of Examples 36-37, further comprising processing the extracted data to determine whether a product associated with each of the plurality of product listings is currently in stock, and further to determine current pricing for each of the plurality of product listings.

Example 39 is a method as in any of Examples 36-38, further comprising storing the extracted data on a search application database, and wherein the method further comprises: processing the unstructured data of the extracted data with the machine learning algorithm to extract missing fields from each of the plurality of product listings.

Example 40 is a method as in any of Examples 36-39, further comprising: processing the extracted data to determine a plurality of relevancy scores, wherein each of the plurality of relevancy scores is associated with one of the plurality of product listings and quantifies a relevance relative to the product descriptor; sorting the plurality of product listings based on the plurality of relevancy scores; and filtering the plurality of product listings based on the plurality of relevancy scores.

Example 41 is a method as in any of Examples 36-40, further comprising generating a product grouping comprising two or more duplicate products offered by two or more vendor websites of the plurality of vendor websites, wherein the two or more duplicate products are associated with a same unique part attribute as identified by the machine learning algorithm.

Example 42 is a method as in any of Examples 36-41, wherein searching the plurality of vendor websites comprises searching in real-time in response to the search request; and wherein scraping the data from each of the plurality of product listings comprises scraping up-to-date data directly from the plurality of vendor websites.

Example 43 is a method as in any of Examples 36-42, further comprising rendering a search progress graphic on a user interface, wherein the search progress graphic comprises an indication of one or more of: a quantity of vendor websites that have been searched; an identity of the plurality of vendor websites; and a quantity of the plurality of product listings that has currently been identified.

Example 44 is a method as in any of Examples 36-43, further comprising initiating a real-time crawler instance for a first vendor website of the plurality of vendor websites, wherein the real-time crawler instance identifies updates made to the first vendor website.

Example 45 is a method as in any of Examples 36-44, further comprising initiating a scraper instance for the first vendor website of the plurality of vendor websites; wherein the scraper instance extracts information from the first vendor website in response to the real-time crawler instance indicating that an update has been made to the first vendor website.

Example 46 is a method as in any of Examples 36-45, further comprising generating a search report for the search request, wherein the search report is rendered on a graphical user interface of a scalable web application, and wherein the search report comprises: one or more product groupings, wherein each of the one or more product groupings is associated with one part attribute of the one or more unique part attributes identified by the machine learning algorithm; wherein each of the one or more product groupings comprises one or more of the plurality of product listings; and wherein each of the one or more product groupings identifies one or more of the plurality of vendor websites that supplies a product with a corresponding part attribute of the one or more unique part attributes.

Example 47 is a method as in any of Examples 36-46, further comprising: receiving a product selection, wherein the product selection identifies at least one of the one or more unique part attributes; identifying one or more of the plurality of vendor websites offering the product selection; and recommending one of the one or more of the plurality of vendor websites for acquiring the product selection.

Example 48 is a method including any combination of any of the method steps of any of Examples 1-47.

The embodiments of systems, methods, and devices discussed herein may be applied to a wide range of sample types for detection of various particles, materials, or the like. The following paragraphs describe diverse types of samples which may be imaged and identified using methods, systems, or devices disclosed herein.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to emphasize their implementation independence more particularly. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by diverse types of processors. An identified component of executable code may, for instance, include one or more physical or logical blocks of computer instructions, which may, for instance, be organized as an object, a procedure, or a function. Nevertheless, the executables of an identified component need not be physically located together but may include disparate instructions stored in separate locations that, when joined logically together, include the component, and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over separate locations including over different storage devices, and may exist, at least partially, merely as electronic signals on a system or network. The components may be passive or active, including agents operable to perform desired functions.

Implementations of the disclosure can also be used in cloud computing environments. In this application, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the claims, if any.

What is claimed is:

1. A method comprising:
receiving a search request comprising a product descriptor;
searching a plurality of vendor websites to identify a plurality of product listings that each comprise information matching the product descriptor;
extracting data from each of the plurality of product listings, wherein the extracted data comprises unstructured data;
providing at least a portion of the extracted data to a machine learning algorithm trained to identify one or more unique part attributes within the portion of the extracted data; and
determining whether two or more of the plurality of product listings are duplicate product listings based on the one or more unique part attributes identified by the machine learning algorithm.

2. The method of claim 1, wherein receiving the search request comprises receiving an input from a user account associated with a scalable web application; and
wherein the method further comprises determining whether the user account is associated with negotiated pricing at any of the plurality of vendor websites.

3. The method of claim 1, further comprising processing the extracted data to determine whether a product associated with each of the plurality of product listings is currently in stock, and further to determine current pricing for each of the plurality of product listings.

4. The method of claim 1, further comprising storing the extracted data on a search application database, and wherein the method further comprises:
processing the unstructured data of the extracted data with the machine learning algorithm to extract missing fields from each of the plurality of product listings.

5. The method of claim 1, further comprising:
processing the extracted data to determine a plurality of relevancy scores, wherein each of the plurality of relevancy scores is associated with one of the plurality of product listings and quantifies a relevance relative to the product descriptor;
sorting the plurality of product listings based on the plurality of relevancy scores; and
filtering the plurality of product listings based on the plurality of relevancy scores.

6. The method of claim 1, further comprising generating a product grouping comprising two or more duplicate products offered by two or more vendor websites of the plurality of vendor websites, wherein the two or more duplicate products are associated with a same unique part attribute as identified by the machine learning algorithm.

7. The method of claim 1, wherein searching the plurality of vendor websites comprises searching in real-time in response to the search request; and
wherein scraping the data from each of the plurality of product listings comprises scraping up-to-date data directly from the plurality of vendor websites.

8. The method of claim 1, further comprising rendering a search progress graphic on a user interface, wherein the search progress graphic comprises an indication of one or more of:
a quantity of vendor websites that have been searched;
an identity of the plurality of vendor websites; and
a quantity of the plurality of product listings that has currently been identified.

9. The method of claim 1, further comprising initiating a real-time crawler instance for a first vendor website of the plurality of vendor websites, wherein the real-time crawler instance identifies updates made to the first vendor website.

10. The method of claim 9, further comprising initiating a scraper instance for the first vendor website of the plurality of vendor websites;
wherein the scraper instance extracts information from the first vendor website in response to the real-time crawler instance indicating that an update has been made to the first vendor website.

11. The method of claim 1, further comprising generating a search report for the search request, wherein the search report is rendered on a graphical user interface of a scalable web application, and wherein the search report comprises:
one or more product groupings, wherein each of the one or more product groupings is associated with one part attribute of the one or more unique part attributes identified by the machine learning algorithm;
wherein each of the one or more product groupings comprises one or more of the plurality of product listings; and
wherein each of the one or more product groupings identifies one or more of the plurality of vendor websites that supplies a product with a corresponding part attribute of the one or more unique part attributes.

12. The method of claim 1, further comprising:
receiving a product selection, wherein the product selection identifies at least one of the one or more unique part attributes;
identifying one or more of the plurality of vendor websites offering the product selection; and
recommending one of the one or more of the plurality of vendor websites for acquiring the product selection.

13. A system comprising one or more processors executing instructions stored in non-transitory computer readable storage medium, wherein the instructions comprise:
receiving a search request comprising a product descriptor;
searching a plurality of vendor websites to identify a plurality of product listings that each comprise information matching the product descriptor;
scraping data from each of the plurality of product listings, wherein the extracted data comprises unstructured data;
providing at least a portion of the extracted data to a machine learning algorithm trained to identify one or more unique part attributes within the portion of the extracted data; and
determining whether two or more of the plurality of product listings are duplicate product listings based on the one or more unique part attributes identified by the machine learning algorithm.

14. The system of claim 13, wherein the instructions are such that receiving the search request comprises receiving an input from a user account associated with a scalable web application; and
wherein the instructions further comprise determining whether the user account is associated with negotiated pricing at any of the plurality of vendor websites.

15. The system of claim 13, wherein the instructions further comprise processing the extracted data to determine whether a product associated with each of the plurality of product listings is currently in stock, and further to determine current pricing for each of the plurality of product listings.

16. The system of claim 13, wherein the instructions further comprise:
processing the extracted data to determine a plurality of relevancy scores, wherein each of the plurality of relevancy scores is associated with one of the plurality of product listings and quantifies a relevance relative to the product descriptor;
sorting the plurality of product listings based on the plurality of relevancy scores; and
filtering the plurality of product listings based on the plurality of relevancy scores.

17. The system of claim 13, wherein the instructions further comprise generating a product grouping comprising two or more duplicate products offered by two or more vendor websites of the plurality of vendor websites, wherein the two or more duplicate products are associated with a same unique part attribute as identified by the machine learning algorithm.

18. The system of claim 13, wherein the instructions are such that searching the plurality of vendor websites comprises searching in real-time in response to the search request; and
wherein the instructions are such that scraping the data from each of the plurality of product listings comprises scraping up-to-date data directly from the plurality of vendor websites.

19. The system of claim 13, wherein the instructions further comprise rendering a search progress graphic on a user interface, wherein the search progress graphic comprises an indication of one or more of:
a quantity of vendor websites that have been searched;
an identity of the plurality of vendor websites; and
a quantity of the plurality of product listings that has currently been identified.

20. The system of claim 13, wherein the instructions further comprise:
initiating a real-time crawler instance for a first vendor website of the plurality of vendor websites, wherein the real-time crawler instance identifies updates made to the first vendor website; and
initiating a scraper instance for the first vendor website of the plurality of vendor websites;
wherein the scraper instance extracts information from the first vendor website in response to the real-time crawler instance indicating that an update has been made to the first vendor website.
